(19) United States
(12) Patent Application Publication
(10) Pub. No.: US 2014/0251651 A1
(43) Pub. Date: Sep. 11, 2014

(54) BRAIDED-SHIELDED CABLE

(71) Applicant: HITACHI CABLE, LTD., Tokyo (JP)

(72) Inventors: Detian HUANG, Hitachi (JP); Takanobu Watanabe, Hitachi (JP); Kimika Kudo, Kitaibaraki (JP); Hiroshi Komuro, Hitachi (JP)

(21) Appl. No.: 13/907,023

(22) Filed: May 31, 2013

(30) Foreign Application Priority Data
Mar. 6, 2013 (JP) 2013-043897

(51) Int. Cl. H01B 9/02

(52) U.S. Cl. CPC H01B 9/024
USPC 174/34

(57) ABSTRACT

A braided-shielded cable includes a braided shield including a shield wire braided. The shield wire includes a twisted wire including seven or nineteen wires twisted together.

The present application is based on Japanese patent application No. 2013-043897 filed on Mar. 6, 2013, the entire contents of which are incorporated herein by reference.

### BACKGROUND OF THE INVENTION

1. Field of the Invention

The invention relates to a braided-shielded cable, i.e., a cable provided with a braided shield.

2. Description of the Related Art

Probe cables electrically connecting a main body and probes in ultrasonic diagnostic equipment are required to be excellent in durability and handling properties. Accordingly, braided-shielded cables excellent in mechanical characteristics such as flex resistance, twist resistance and flexibility are used as the probe cables.

In conventional braided-shielded cables, a metallic foil-wrapped yarn formed by spirally winding a metal strip around a high tensile-strength fiber excellent in mechanical characteristics is used to form a braded shield, thereby realizing very high flex and twist resistance of not less than 560,000 cycles in a flex-and-twist life test in which a combination of ±135° bend and ±180° twist is defined as one cycle.

The art related to the present invention may be disclosed in Patent Literature 1: JP-A-2003-217359.

### SUMMARY OF THE INVENTION

However, since the metallic foil-wrapped yarn includes non-conductive high tensile-strength fibers and the metal strip spirally wound around the high tensile-strength fibers behaves as an inductor, the braided shield formed of the metallic foil-wrapped yarn has poorer electrical characteristics, such as noise tolerance, than a braided shield formed of a metal wire.

Meanwhile, the braided shield formed of a metal wire is entirely conductive and is thus excellent in electrical characteristics. However, the metal wire has poorer mechanical characteristics than the metallic foil-wrapped yarn, and therefore, it is only possible to realize flex and twist resistance of about 250,000 cycles even if using a hard copper alloy wire which has, among any other metal wires, excellent mechanical characteristics such as a tensile strength of not less than 800 MPa.

It is an object of the invention to provide a braided-shielded cable that is excellent in both mechanical characteristics and electrical characteristics.

(1) According to one embodiment of the invention, a braided-shielded cable comprises:

a braided shield comprising a shield wire braided,

wherein the shield wire comprises a twisted wire comprising seven or nineteen wires twisted together.

In the above embodiment (1) of the invention, the following modifications and changes can be made.

(i) The wire comprises a copper alloy wire having a tensile strength of not less than 300 MPa and an elongation of not less than 5%.

(ii) The wire has an outer diameter of not less than 0.025 mm and not more than 0.04 mm.

(iii) The braided shield has a braid coverage of not less than 90% and not more than 98% and a braid angle of not less than 35° and not more than 45°.

(iv) The braided-shielded cable further comprises:

a center inclusion;

a plurality of cable units twisted around the center inclusion, the braided shield being formed around the plurality of cable units; and

a sheath layer formed around the braided shield.

### POINTS OF THE INVENTION

According to one embodiment of the invention, a braided-shielded cable is constructed such that a shield wire is braided by using a twisted wire formed by twisting seven or nineteen wires together. Thus, the cross sectional shape of the shield wire is close to a perfect circle as compared to a twisted wire formed by twisting two or three wires. Therefore, the interference between adjacent shield wires by being stuck or tangled with each other can be reduced even when the shield wires come into contact with each other, so that the shield wire is unlikely to be damaged or broken thereby.

### BRIEF DESCRIPTION OF THE DRAWINGS

Next, the present invention will be explained in more detail in conjunction with appended drawings, wherein:

FIG. 1 is a side view with a partially enlarged portion showing a braided-shielded cable of the present invention;

FIG. 2 is a cross sectional view showing a probe cable which is an illustrative embodiment of the braided-shielded cable of FIG. 1;

FIG. 3 is a diagram illustrating a shielding effectiveness of the braided-shielded cable in Example 1; and

FIG. 4 is a diagram illustrating a shielding effectiveness of the braided-shielded cable in Comparative Example 1.

### DETAILED DESCRIPTION OF THE PREFERRED EMBODIMENTS

A preferred embodiment of the invention will be described below in conjunction with the appended drawings.

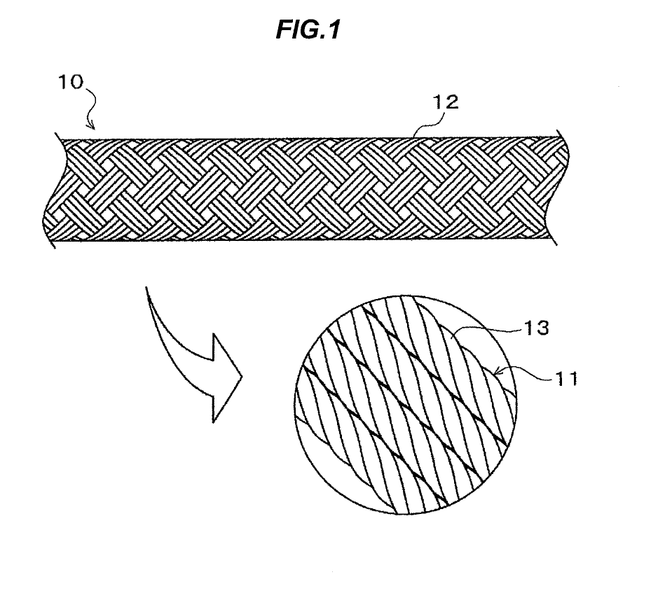

As shown in FIG. 1, a braided-shielded cable 10 in the present embodiment is provided with a braided shield 12 formed by braiding a shield wire 11 and is characterized in that the shield wire 11 is a twisted wire formed by twisting seven or nineteen wires 13 together.

The braided-shielded cable 10 realizes very high flex and twist resistance of not less than 560,000 cycles in a flex-and-twist life test, in which a combination of ±135° bend and ÷180° twist is defined as one cycle, without using a metallic foil-wrapped yarn which has poorer electrical characteristics.

It is preferable that the wire 13 be a copper alloy wire having a tensile strength of not less than 300 MPa and an elongation of not less than 5%. This is because the above-mentioned flex resistance cannot be realized at a tensile strength of less than 300 MPa and the above-mentioned twist resistance cannot be realized at elongation of less than 5%. The copper alloy wire having a tensile strength of not less than 300 MPa and an elongation of not less than 5% includes, e.g., a soft copper alloy wire. Note that, the copper alloy wire may be plated with tin.

Furthermore, it is preferable that the wire 13 have an outer diameter of not less than 0.025 mm and not more than 0.04 mm. This is because, when the outer diameter is less than 0.025 mm, the wire 13 constituting the shield wire 11 cannot satisfy the minimum required mechanical strength and it is thus not possible to realize the above-mentioned flex resistance and twist resistance. On the other hand, the outer diameter of more than 0.04 mm causes an excessive increase in a proportion of the braided shield 12 in an outer diameter of a cable, which impedes reduction in cable diameter.

It is preferable that the braided shield 12 have braid coverage of not less than 90% and not more than 98%. This is because, when the braid coverage is less than 90%, a proportion of void in the braided shield 12 per unit area is excessively high, which results in a decrease in noise tolerance. On the other hand, when the braid coverage is more than 98%, a proportion of void in the braided shield 12 per unit area is too low and the shield wire 11 can hardly move, which causes problems that stress applied to the shield wire 11 when the braided-shielded cable 10 is bent or twisted cannot be released and the shield wire 11 may be broken after buckling, and in addition to this, the braided-shielded cable 10 becomes entirely hard and flexibility decreases.

Furthermore, it is preferable that a braid angle of the braided shield 12 be not less than 35° and not more than 45°. This is because, when the braid angle is less than 35°, the braided shield 12 is close to a shield in which the state of the shield wires 11 are longitudinally applied and it is not possible to obtain advantages of the braid, i.e., excellent flex resistance and twist resistance. On the other hand, when the braid angle is more than 45°, it is not possible to pull out an end portion of the cable while gathering the braided shield 12 toward the middle of the cable at the time of terminal processing of the braided-shielded cable 10 and this causes a decrease in terminal workability, and in addition to this, the braided-shielded cable 10 becomes entirely hard and flexibility decreases.

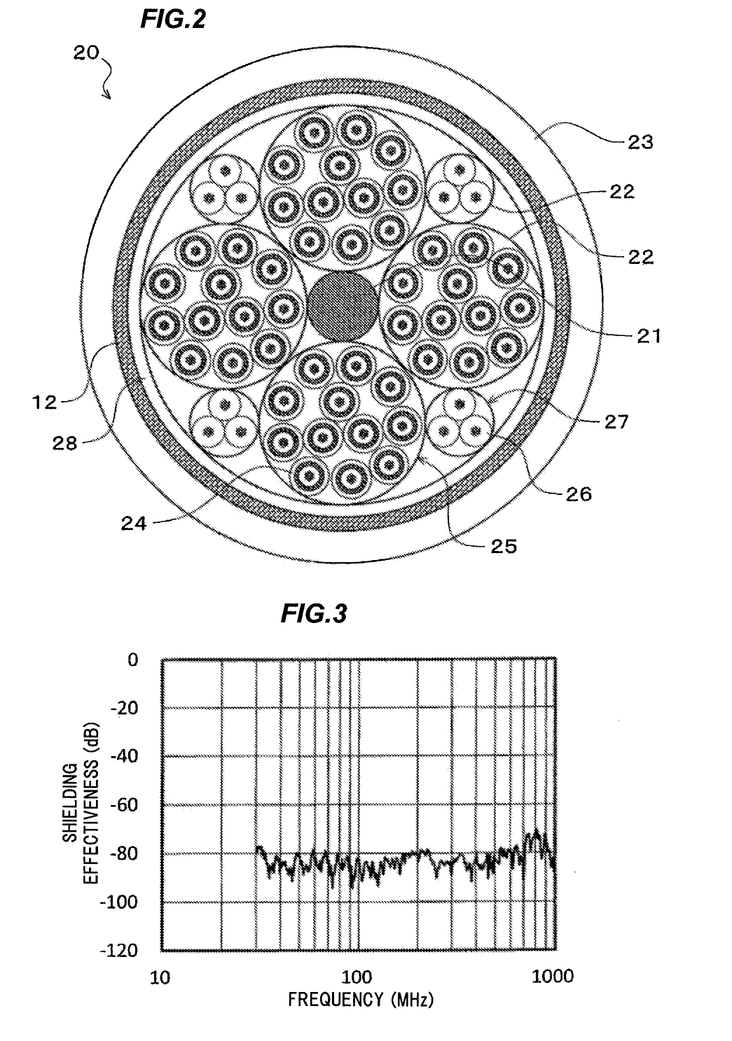

The illustrative embodiment of the braided-shielded cable 10 includes a probe cable 20 shown in FIG. 2.

The probe cable 20 is provided with a center inclusion (tension member) 21, plural cable units 22 twisted around the center inclusion 21, the braided shield 12 formed around the plural cable units 22 and a sheath layer 23 formed around the braided shield 12.

The center inclusion 21 is to improve flex resistance, twist resistance and flexibility of the probe cable 20 such that the plural cable units 22 twisted together in a state of being concentrically arranged around the center inclusion 21 maintain symmetry of the probe cable 20 to allow an external force to be dispersed.

The center inclusion 21 is, e.g., a high tensile-strength fiber formed of polyamide-based fiber such as aramid or polyester-based fiber such as polyethylene terephthalate in order to improve resistance against, e.g., tension applied in a longitudinal direction of the cable.

A signal transmission unit 25 formed by assembling plural coaxial cables 24 and a power-supply unit 27 formed by assembling plural insulated cables 26 are used as the cable unit 22.

A binder tape (binding tape) 28 is wound around all of the cable units 22 and maintains a twisted shape of the plural cable unit 22 which are concentrically arranged in a cross section of the cable.

As described above, in the braided-shielded cable 10 of the present embodiment, the entire shield wire 11 has conductivity since the shield wire 11 constituting the braided shield 12 is a twisted wire and it is therefore possible to realize electrical characteristics equivalent to those of a braided shield formed of a metal wire.

In addition, since the twisted wire has better flex resistance, twist resistance and flexibility than a solid wire, it is possible to realize very high flex and twist resistance of not less than 560,000 cycles while having excellent flexibility.

Especially in case that the braided shield 12 is covered with another layer such as the case where the sheath layer 23 is formed around the braided shield 12, the shield wire 11 constituting the braided shield 12 cannot easily move and buckling is likely to occur when the braided-shielded cable 10 is bent or twisted. However, the twisted wire is stronger against buckling and has a longer fatigue life than the solid wire and it is therefore possible to sufficiently satisfy the above-mentioned mechanical characteristics.

In addition, since the braided shield 12 is less likely to be damaged even when receiving an external force at the time of terminal processing, terminal workability at the time of, e.g., folding back or gathering and pulling out the braided shield 12 is excellent.

Furthermore, since the shield wire 11 is a twisted wire formed by twisting seven or nineteen wires 13 together, the cross sectional shape of the shield wire 11 is close to a perfect circle as compared to that of a twisted wire formed by twisting two or three wires 13. Therefore, interference between adjacent shield wires 11, such as getting stuck with each other, less occurs even when the shield wires 11 come into contact with each other, and accordingly, damage to the shield wire 11 and the resulting breakage are unlikely to occur. In addition, since the number of the shield wires 11 is not more than nineteen, a proportion of the braided shield 12 in the outer diameter of the cable does not become excessively high and reduction in cable diameter is not impeded.

As described above, according to the invention, it is possible to provide the braided-shielded cable 10 which is excellent in both mechanical characteristics and electrical characteristics.

### EXAMPLE

Example of the invention will be described below in reference to Table 1.

TABLE 1

| | | | Comparative |
|---|---|---|---|
| | | Example 1 | Example 1 |
| Outer diameter of Cable | | 8.3 mm | 8.3 mm |
| Flex-and-twist life test | | Not less than | Not less than |
| | | 560,000 cycles | 560,000 cycles |
| Braid wire | Structure | 7/0.03 mm, | 0.11 mm, Copper |
| | | Copper alloy | foil-wrapped |
| | | twisted wire | yarn solid |
| | | | wire |
| | Tensile strength | 330 MPa | — |
| | Breaking strength | 1.63 N | 4.00 N |
| | Elongation | 7% | 15% |

| | | |
|---|---|---|
| Braid angle | 38° | 35° |
| Braid coverage | 91% | 96% |
| Braided shield resistance | 3.2 Ω/m | 20 Ω/m |

### Example 1

In a braided-shielded cable of Example 1, a shield wire which is a twisted wire formed by twisting seven copper alloy wires was used as a braid wire to form a braided shield. Here, an outer diameter of the copper alloy wire was 0.03 mm and an outer diameter of the cable was 8.3 mm.

In this braided-shielded cable, each braid wire had a tensile strength of 330 MPa, a breaking strength of 1.63 N, elongation of 7%, a braid angle of 38°, braid coverage of 91% and braided shield resistance of 3.2 Ω/m.

### Comparative Example 1

In a braided-shielded cable of Comparative Example 1, a copper foil-wrapped yarn formed by spirally winding a copper strip around a high tensile-strength fiber was used as a braid wire to form a braided shield. Here, an outer diameter of the copper foil-wrapped yarn was 0.11 mm. The outer diameter of the cable was 8.3 mm in the same manner as Example 1.

In this braided-shielded cable, each braid wire had a breaking strength of 4.00 N, elongation of 15%, a braid angle of 35°, braid coverage of 96% and braided shield resistance of 20 Ω/m

Flex-and-Twist Life Test

Each of the braided-shielded cables in Example 1 and Comparative Example 1 was cut to form a test piece having a cable length of 2.2 m, and the flex-and-twist life test in which a combination of ±135° bend and ±180° twist is defined as one cycle was conducted on the test pieces and cycles of the flex and twist resistance were examined. As shown in Table 1, both braided-shielded cables had a target flex and twist resistance of 560,000 cycles.

Measurement of Shielding Effectiveness

Each of the braided-shielded cables in Example 1 and Comparative Example 1 was cut to form a test piece to form a test piece having a cable length of 10 m. Then, an end portion of the test piece was terminated at a 50Ω resistor to apply electromagnetic wave and shielding effectiveness was measured using an absorbing clamp (KT-10 manufactured by Kyoritsu Corporation) and a network analyzer (8751A manufactured by

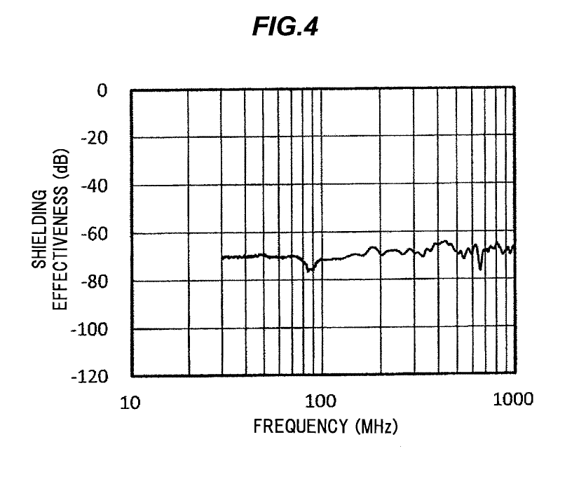

Hewlett-Packard Company for measurement in a frequency range of not less than 30 MHz and not more than 500 MHz and 8722ES manufactured by Agilent for measurement in a frequency range of not less than 500 MHz and not more than 1 GHz) connected to the absorbing clamp. In the braided-shielded cable Example 1, shielding effectiveness of not more than −80 dB was obtained in a wide frequency range, as shown in FIG. 3. However, in the braided-shielded cable Comparative Example 1, shielding effectiveness of only about −70 dB was obtained in any frequency range, as shown in FIG. 4.

The above result demonstrates that the invention can provide a braided-shielded cable which is excellent in both mechanical characteristics and electrical characteristics.

Although the invention has been described with respect to the specific embodiment for complete and clear disclosure, the appended claims are not to be therefore limited but are to be construed as embodying all modifications and alternative constructions that may occur to one skilled in the art which fairly fall within the basic teaching herein set forth.

What is claimed is:

1. A braided-shielded cable, comprising:
a braided shield comprising a shield wire braided,
wherein the shield wire comprises a twisted wire comprising seven or nineteen wires twisted together.

2. The braided-shielded cable according to claim 1, wherein the wire comprises a copper alloy wire having a tensile strength of not less than 300 MPa and an elongation of not less than 5%.

3. The braided-shielded cable according to claim 1, wherein the wire has an outer diameter of not less than 0.025 mm and not more than 0.04 mm.

4. The braided-shielded cable according to claim 1, wherein the braided shield has a braid coverage of not less than 90% and not more than 98% and a braid angle of not less than 35° and not more than 45°.

5. The braided-shielded cable according to claim 1, further comprising:
a center inclusion;
a plurality of cable units twisted around the center inclusion, the braided shield being formed around the plurality of cable units; and
a sheath layer formed around the braided shield.
